(19) United States
(12) Patent Application Publication
(10) Pub. No.: US 2026/0056395 A1
(43) Pub. Date: Feb. 26, 2026

(54) OPTICAL APPARATUS AND IMAGE PICKUP APPARATUS

(71) Applicant: CANON KABUSHIKI KAISHA, Tokyo (JP)

(72) Inventors: KOHEI UEMURA, Kanagawa (JP); TOSHIHIRO OGAWA, Tokyo (JP); TORU ISHIMASA, Kanagawa (JP)

(21) Appl. No.: 19/259,288

(22) Filed: Jul. 3, 2025

(30) Foreign Application Priority Data
Aug. 23, 2024 (JP) 2024-143385

(51) Int. Cl. G02B 15/04; G02B 7/02

(52) U.S. Cl. CPC G02B 15/04; G02B 7/021

(57) ABSTRACT

An optical apparatus includes an optical system that includes first, second, and third lens units, a first holding member that includes a first stopper portion and holds the second lens unit, a second holding member that includes a first restricting portion and a second stopper portion and holds the third lens unit, and a fixed member that includes a second restricting portion and holds the first holding member and the second holding member. The second and third lens units are movable between a first state in which they are located outside an optical path of the optical system and a second state in which they are located in the optical path of the optical system. In a case where the second and third lens units are in the second state, the first restricting portion contacts the first stopper portion, and the second restricting portion contacts the second stopper portion.

### BACKGROUND

### Field of the Technology

The present disclosure relates to one or more embodiments of an optical apparatus and an image pickup apparatus that can change a focal length range of a master lens by inserting or retracting a built-in conversion lens.

### Description of the Related Art

Some known optical apparatus, such as digital cameras, video cameras, and interchangeable lenses, are configured to insert a conversion lens into an optical path to change a focal length range of an imaging optical system toward a telephoto or wide-angle side. Japanese Patent Application Laid-Open No. 11-311828 discloses a configuration that can move a conversion lens built into a camera body between an inserted position where it is inserted into the optical path, and a retracted position where it is retracted from the optical path.

However, in the configuration disclosed in Japanese Patent Application Laid-Open No. 11-311828 while the conversion lens is located in the inserted position, its position is restricted by a part other than the part that holds the conversion lens, and thus the optical performance may deteriorate.

### SUMMARY

One or more embodiments of an optical apparatus according to one or more aspects of the present disclosure may include an optical system that includes a first lens unit, a second lens unit, and a third lens unit, a first holding member that includes a first stopper portion and holds the second lens unit, a second holding member that includes a first restricting portion and a second stopper portion and holds the third lens unit, and a fixed member that includes a second restricting portion and holds the first holding member and the second holding member. The second lens unit and the third lens unit are movable between a first state in which the second lens unit and the third lens unit are located outside an optical path of the optical system and a second state in which the second lens unit and the third lens unit are located in the optical path of the optical system. In a case where the second lens unit and the third lens unit are in the second state, the first restricting portion contacts the first stopper portion, and the second restricting portion contacts the second stopper portion. One or more image pickup apparatuses may include one or more optical apparatuses in accordance with one or more other aspects of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a front perspective view of an interchangeable lens and a camera body in a case where an imaging optical system has a second focal length range.

FIG. 2 is a rear perspective view of the interchangeable lens and the camera body in a case where the imaging optical system has the second focal length range.

FIG. 3 is a sectional view of the interchangeable lens and the camera body in a case where the imaging optical system has the second focal length range.

FIG. 4 is a sectional view of the interchangeable lens and the camera body in a case where the imaging optical system has a first focal length range.

FIG. 5 is an external view of each lens unit in a case where the imaging optical system has the second focal length range.

FIG. 6 is an external view of each lens unit in a case where the imaging optical system is in transition.

FIG. 7 is an external view of each lens unit in a case where the imaging optical system is in transition.

FIG. 8 is an external view of each lens unit in a case where the imaging optical system has the first focal length range.

FIGS. 9A and 9B are perspective views of each lens unit and a base member when viewed from the object side.

FIGS. 10A and 10B are perspective views of each lens unit and the base member viewed from the image plane side.

FIG. 11 is an external view of each lens unit and the base member when viewed from the Z direction.

FIGS. 12A and 12B are sectional views taken along a line A-A in FIG. 11.

FIGS. 13A and 13B are sectional views taken along a line B-B in FIG. 11.

FIG. 14 is a graph illustrating a distance in a radial direction from the center of gravity of each lens unit to the first optical axis in a case where the imaging optical system transitions between the first focal length range and the second focal length range.

### DESCRIPTION OF THE EMBODIMENTS

Referring now to the accompanying drawings, a detailed description will be given of embodiments according to the present disclosure. Corresponding elements in respective figures will be designated by the same reference numerals, and a duplicate description thereof will be omitted.

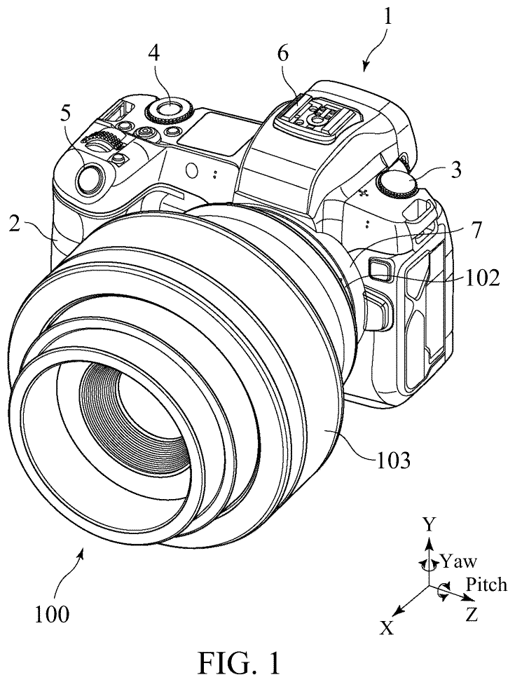

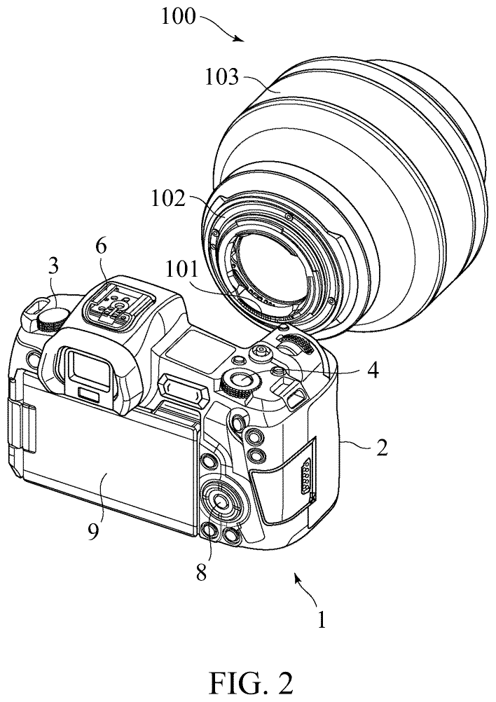

FIGS. 1 and 2 illustrate the appearance of an interchangeable lens 100, which is an example of an optical apparatus according to this embodiment of the present disclosure, and a digital camera (referred to as a camera body hereinafter) 1 to which the interchangeable lens 100 is detachably attached.

FIG. 1 is a front perspective view of the interchangeable lens 100 and digital camera 1 in a case where the imaging optical system has a second focal length range. FIG. 2 is a rear perspective view of the interchangeable lens 100 and camera body 1 in a case where the imaging optical system has the second focal length range. FIG. 2 illustrates a state in which the interchangeable lens 100 has been detached from the camera body 1.

In this embodiment, as illustrated in FIG. 1, an optical axis direction in which the optical axis of the imaging optical system housed in the interchangeable lens 100 extends (the direction along the optical axis) is defined as an X-axis direction, and directions orthogonal to the X-axis direction are defined as a Z-axis direction (horizontal direction) and a Y-axis direction (vertical direction). Hereinafter, the Z-axis direction and the Y-axis direction will be collectively referred to as a Z/Y-axis direction. A rotation direction around the Z-axis is a pitch direction, and a rotation direction around the Y-axis is a yaw direction.

The pitch direction and yaw direction (collectively referred to as a pitch/yaw direction hereinafter) are the rotation directions around two mutually orthogonal axes, that is, the Z-axis and the Y-axis.

While the present disclosure will be described in this embodiment as being applied to an interchangeable lens, the present disclosure can also be applied to other optical apparatuses and image pickup apparatuses such as a lens integrated type camera.

A grip portion 2 is provided on the left side of the camera body 1 when viewed from the front (the right side when viewed from the back) for a user to hold the camera body 1 with his hand. A power operation unit 3 is also provided on the top surface of the camera body 1. In a case where the camera body 1 is in a power-off state and the user turns on the power operation unit 3, power is supplied to the camera body 1, which then switches the camera body 1 to a power-on state, and a computer program such as origin detection processing for the focus unit (focus lens) is executed and the camera body 1 becomes in an imaging standby state. Conversely, in a case where the camera body 1 is in a power-on state and the user turns off the power operation unit 3, the camera body 1 goes into a power-off state.

A mode dial 4, a release button 5, and an accessory shoe 6 are provided on the top surface of the camera body 1. The user can switch an imaging mode by rotating the mode dial 4. The imaging mode includes a manual still image capturing mode in which the user can arbitrarily set an imaging condition such as a shutter speed and an aperture value (F-number), an auto still image capturing mode in which a proper exposure amount is automatically obtained, and a moving image capturing mode for capturing a moving image. In addition, the user can instruct an imaging preparation operation such as autofocus (AF) and auto-exposure (AE) control by half-pressing the release button 5, and can instruct imaging by fully pressing it. An accessory (camera accessory) such as an external flash or another illumination apparatus or light-emitting apparatus is detachably attached to the accessory shoe 6.

The interchangeable lens 100 has a lens mount 102 that can be mechanically connected to a camera mount 7 provided on the camera body 1. The interchangeable lens 100 has an electrical connection member 101 and is electrically connected to the camera body 1. As illustrated in FIG. 2, the electrical connection member 101 in this embodiment is disposed at the lower phase in the circumferential direction of the lens mount 102, but the present disclosure is not limited to this example, and may be disposed at an upper phase.

An imaging optical system that forms an object image on an image plane using light from an object is housed inside the interchangeable lens 100. A focus ring (operation member) 103 rotatable around the optical axis by a user operation is provided on the outer circumference of the interchangeable lens 100. For example, in a manual focus mode, in a case where the user rotates the focus ring 103, the entire lens unit or a part of the lens unit (focus unit) that constitutes the imaging optical system moves to a predetermined use position corresponding to the angle of the focus ring 103. Thus, the user can perform focusing.

As illustrated in FIG. 2, a rear operation unit 8 and a display unit 9 are provided on the rear surface of the camera body 1. The rear operation unit 8 includes a plurality of buttons and dials to which a variety of functions are assigned. In a case where the camera body 1 is powered on and the still or moving image capturing mode is set, the display unit 9 displays a through-image of the object image captured by the image sensor described later. The display unit 9 also displays an imaging parameter indicating an imaging condition such as a shutter speed and an aperture value (F-number), and the user can change the setting of the imaging parameter by operating the rear operation unit 8 while viewing the display. The rear operation unit 8 includes a playback button for instructing playback of a recorded captured image, and the captured image is played and displayed on the display unit 9 in a case where the user operates the playback button. The display unit 9 may be of a touch panel type and have the same function as that of the rear operation unit 8.

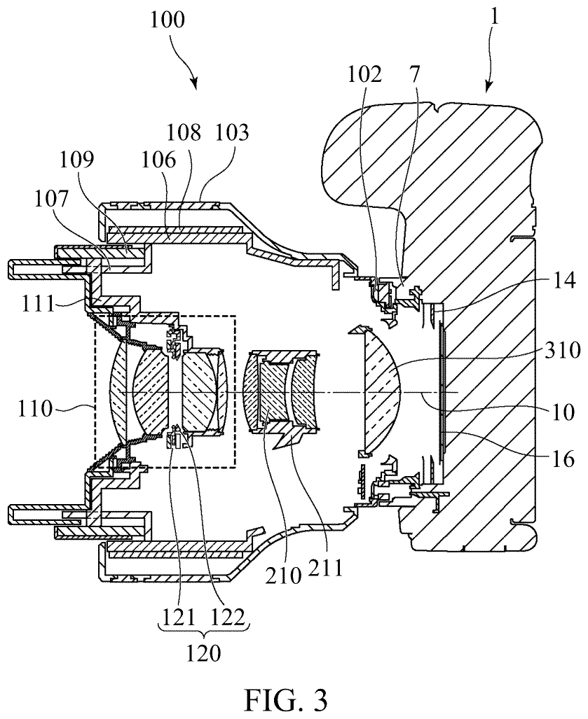

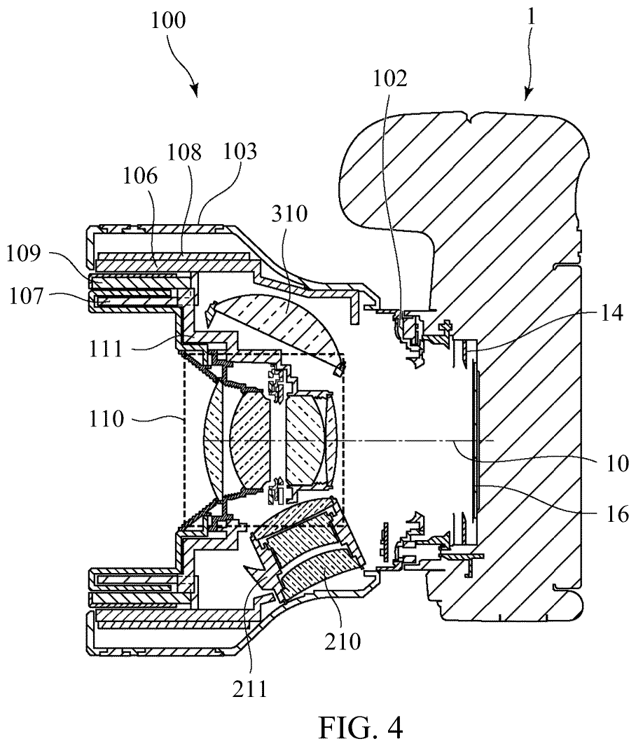

Referring now to FIGS. 3 and 4, a description will be given of a positional relationship of the members (components) that constitute the interchangeable lens 100. FIG. 3 is a sectional view illustrating the XZ plane of the interchangeable lens 100 and the camera body 1 from above in the Y-axis direction in a case where the imaging optical system has a second focal length range. FIG. 4 is a sectional view illustrating the XZ plane of the interchangeable lens 100 and the camera body 1 from above in the Y-axis direction in a case where the imaging optical system has a first focal length range. The centerline illustrated here approximately coincides with the first optical axis 10 determined by the first lens unit 110, and is therefore hereinafter synonymous with the X-axis described above. An imaging surface 16 of the image sensor is orthogonal to the first optical axis 10 and is synonymous with the YZ plane described above.

FIG. 3 illustrates a case where the second lens unit 210 and the third lens unit 310 are disposed closer to the image plane than the first lens unit 110, and the focal length range of the imaging optical system is the second focal length range. FIG. 4 illustrates a case where the second lens unit 210 and the third lens unit 310 are retracted from the first optical axis 10, the first lens unit 110 moves into the vacant space, and the focal length range of the imaging optical system is the first focal length range. Here, FIG. 3 illustrates a state where the overall length of the interchangeable lens 100 is longer, and FIG. 4 illustrates a state where the overall length is shorter, and imaging can be performed in both the states.

In this embodiment, the imaging optical system includes the first lens unit 110 as a master lens, and the second lens unit 210 and third lens unit 310 as extender lenses, which are a type of conversion lens. In a case where only the first lens unit 110 is disposed on the first optical axis 10 and the second lens unit 210 and the third lens unit 310 are not on the first optical axis 10, the focal length range of the imaging optical system is the first focal length range. On the other hand, in a case where the second lens unit 210 and the third lens unit 310 are inserted on the first optical axis 10 on the image plane side of the first lens unit 110, the focal length range of the imaging optical system is changed from the first focal length range to the second focal length range. At this time, the first focal length range is a wide-angle side with a short focal length, and the second focal length range is a telephoto side with a long focal length. In the following description, the expression such as “from the first focal length range to the second focal length range” means “a focal length range of the imaging optical system is from the first focal length range to the second focal length range.”

The interchangeable lens 100 includes a first holding frame 111 that holds the first lens unit 110, and a first cam barrel 108 and a second cam barrel 109 that move the first holding frame 111 along the first optical axis 10. Thereby, the first lens unit 110 can move along the first optical axis 10 in each focal length range, and thereby focusing can be performed.

As will be described in more detail later, the interchangeable lens 100 can switch between the first focal length range and the second focal length range without using a dedicated actuator. As an example, FIGS. 1 to 3 illustrate a case where the second focal length range on the telephoto side is adopted. In a case where the user rotates the focus ring 103 in a direction toward infinity from the second focal length range illustrated in the figures, the first lens unit 110 moves toward the image plane side in conjunction with the rotation. At this time, the second lens unit 210 held by a second holding frame (first holding member) 211 and the third lens unit 310 held by a third holding frame (second holding member) 311 are retracted from the first optical axis 10 to their respective retracted positions. Moving the first lens unit 110 into the space thus created and further retracting it toward the image plane side provides the state illustrated in FIG. 4, and reduces the overall lens length of the entire interchangeable lens 100.

In this embodiment, the master lens includes a single lens unit and the extender lens includes two lens units, but the present disclosure is not limited to this embodiment. For example, the master lens may include a plurality of lens units, or include another independent focus unit and an image stabilizing unit, or the extender lens may consist of a single lens unit. In addition, the conversion lens is the extender lens in this embodiment, but it may be a wide conversion lens, a macro lens, or a reducer lens.

The first lens unit 110 includes an aperture (stop) unit 120 that adjusts a light amount, and is held by the first holding frame 111. The aperture unit 120 includes an aperture drive unit (not illustrated), a plurality of aperture blades 121, and a drive ring 122, and the aperture drive unit adjusts a light amount by changing an opening shape of the aperture blades 121 via the drive ring 122.

A shutter unit 14 disposed in the camera body 1 is a focal plane shutter having a front blade and a rear blade, each of which includes a plurality of light-shielding blades. During imaging, the front blade travels from a light-shielding position where the exposure opening is closed to an exposure position where the exposure opening is opened, and light from the object passes toward the image plane. Thereafter, in a case where the set exposure time elapses, the rear blade travels from the exposure position to the light-shielding position. At this time, the direction in which the front blade and the rear blade travel is approximately the same as the short side direction of the image sensor in the camera body 1, i.e., the Y-axis.

The light ray that enters the interchangeable lens 100 from the object side passes through the aperture shape formed by the aperture blades 121 while being subjected to the light refraction action of the first lens unit 110. In the state illustrated in FIG. 3, the light ray is further subjected to the light refraction action of the second lens unit 210 and the third lens unit 310, then passes through the opening of the shutter unit 14, and forms as an object image on the image plane. On the other hand, in the state illustrated in FIG. 4, the light ray passes through the opening of the shutter unit 14 without being subjected to the light refraction action of the second lens unit 210 and the third lens unit 310, and forms an object image on the image plane. In other words, a route (optical path) that the light ray follows differs according to whether the imaging optical system has the first focal length range or the second focal length range.

The fixed barrel 106 is a fixed member fixed to the lens mount 102. The fixed barrel 106 has linear guide grooves (not illustrated) formed in three equal parts in the circumferential direction, which are engaged with linear keys (not illustrated) provided on the linear guide barrel 107 to restrict the linear guide barrel 107 from moving in the rotational direction and to guide the linear guide barrel 107 along the first optical axis 10. On the outer circumferential side of the fixed barrel 106, a first cam barrel 108 is held rotatably about the first optical axis 10 by a bayonet (not illustrated), and the first cam barrel 108 is connected to the focus ring 103 via a coupling key (not illustrated). The linear guide barrel 107 has linear guide grooves (not illustrated) formed in three equal parts in the circumferential direction, which are engaged with linear keys (not illustrated) provided on the first holding frame 111, like the fixed barrel 106. The linear key is fitted into (engaged with) the linear guide groove to restrict the first holding frame 111 from moving in the rotational direction, and to guide the first holding frame 111 along the first optical axis 10. The second cam barrel 109 is held by a bayonet (not illustrated) on the outer circumference of the linear guide barrel 107 rotatably about the first optical axis 10.

On the inner circumferences of the first cam barrel 108 and the second cam barrel 109, first cam grooves and second cam grooves (not illustrated) that fit with (are engaged with) cam followers (not illustrated) provided on the linear guide barrel 107 and the first holding frame 111, respectively, are formed in three equal parts in the circumferential direction. At this time, the second cam barrel 109 is configured to move integrally with the linear guide barrel 107 along the first optical axis 10. On the other hand, the first cam barrel 108 and the second cam barrel 109 are restricted from rotating by the connecting keys (not illustrated), and while moving relatively along the first optical axis 10, they rotate in a connected manner in the circumferential direction. Therefore, in a case where the user rotates the focus ring (focusing ring) 103, the first holding frame 111 moves along the first optical axis 10 while being restricted from moving in the rotational direction via the linear guide barrel 107 and the second cam barrel 109.

This embodiment adopts such a so-called two-step extension type lens barrel configuration, moves the first lens unit 110 into the space created by the retraction of the second lens unit 210 and the third lens unit 310. In particular, as illustrated in FIG. 4, in a case where the first focal length range on the wide-angle side is taken, the first lens unit 110 can be retracted toward the image plane side to reduce the overall length of the interchangeable lens 100 and achieve high portability.

In one conventional configuration, the overall lens length in the optical axis direction is reduced by retracting a retractable lens unit from the optical axis of an imaging optical system, and a distance between lens units is reduced, and the lens units are moved storage positions at which they are close to each other. This configuration employs a retractable mechanism that transitions from an imaging state to a non-imaging state, and imaging cannot be performed in the retracted state in which the overall lens length is reduced. Thus, although portability is high, extra time is required to transition from a retracted state in which imaging is restricted to an imageable state.

In the imaging optical system according to this embodiment, the second lens unit 210 and the third lens unit 310 are retracted to create the first focal length range, and imaging can be performed even in the state in which the overall lens length of FIG. 4 is reduced. In other words, in comparison with an optical apparatus employing a general retractable mechanism, the time required to start imaging can be reduced, high portability can be achieved, and loss of photo opportunities can be suppressed

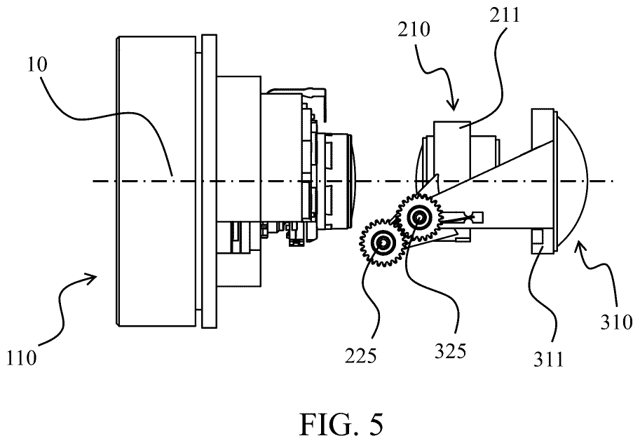

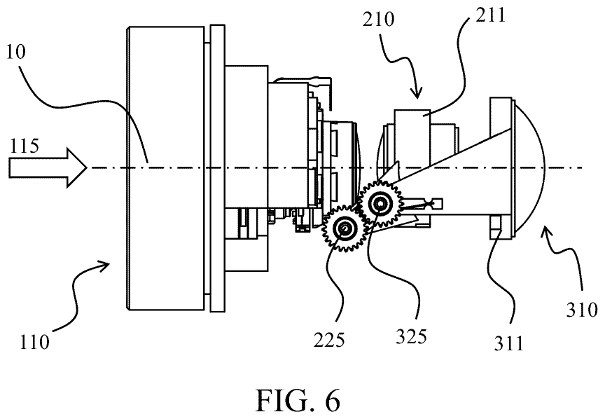

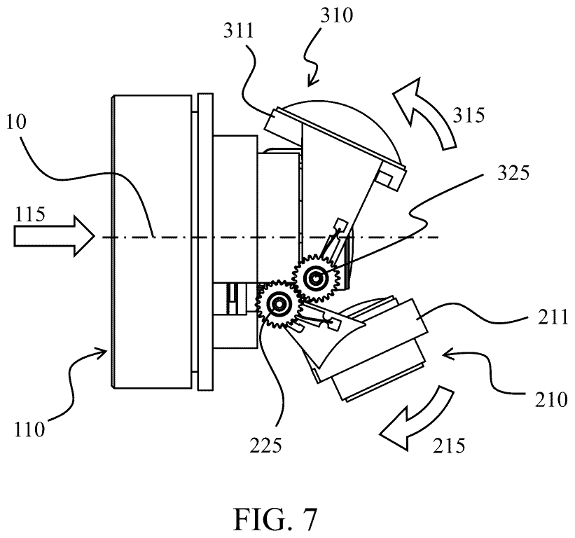

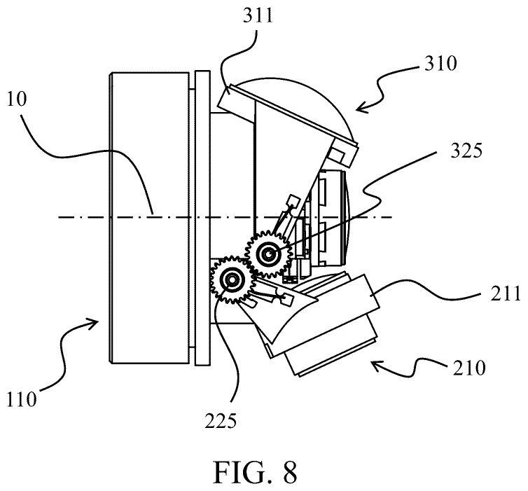

Referring now to FIGS. 5 to 8, a description will be given of the movement of each lens unit in the imaging optical system. FIGS. 5 to 8 explain the appearance of the first lens unit 110, the second lens unit 210, and the third lens unit 310, and are diagrams of the XZ plane when viewed from above in the Y-axis direction, illustrating the transition from the second focal length range to the first focal length range. FIG. 5 is an external view of each lens unit in a case where the imaging optical system has the second focal length range. FIGS. 6 and 7 are external views of each lens unit in a case where the imaging optical system is in transition. FIG. 8 is an external view of each lens unit in a case where the imaging optical system has the second focal length range.

In FIG. 5, the first lens unit 110, the second lens unit 210, and the third lens unit 310 are arranged in this order from the object side at arbitrary positions on the first optical axis 10. In a case where the imaging optical system has the second focal length range, the first lens unit 110 is moved along the first optical axis 10 to perform focusing. At this time, the second lens unit 210 and the third lens unit 310 remain in the optical path and do not move.

The second holding frame 211 includes a first rotation shaft 225, and the third holding frame 311 includes a second rotation shaft 325. Each of the first rotation shaft 225 and the second rotation shaft 325 has a first end fixed to the base member 410, and holds the second holding frame 211 and the third holding frame 311 rotatably relative to the base member 410. The direction in which the center of the first rotation shaft 225 extends and the direction in which the center of the second rotation shaft 325 extends are approximately parallel to each other and approximately orthogonal to the first optical axis 10. The first rotation shaft 225 and the second rotation shaft 325 may have a double-supported structure in which they are divided into two and arranged symmetrically to each other when viewed from the direction of the first optical axis 10. This embodiment employs the double-supported structure, which is more beneficial than a single-supported structure in terms of rigidity and durability, and as illustrated in FIG. 8, the first rotation shaft 225 and the second rotation shaft 325 are arranged at a position where they overlap with the first lens unit 110 in the direction of the first optical axis 10.

As illustrated in FIGS. 3 and 4, the first lens unit 110 and the second lens unit 210 are always arranged on the object side of the connection surface (mount surface) between the camera mount 7 and the lens mount 102 in the direction of the first optical axis 10. In a case where the imaging optical system has the second focal length range, at least a part of the third lens unit 310 overlaps with the mount surface. If a lens with a relatively large diameter like the third lens unit 310 were to be retracted around a rotation axis parallel to the first optical axis 10, a large space would be required in the outer diameter direction of the interchangeable lens 100. In a case where a part that is difficult to avoid, such as the lens mount 102, is provided in the outer diameter space to which the third lens unit 310 is to be retracted, the third lens unit 310 cannot be retracted completely from the first optical axis 10.

Accordingly, in this embodiment, the second rotation shaft 325 is approximately orthogonal to the first optical axis 10, so that in a case where the imaging optical system has the first focal length range, the third lens unit 310 is retracted to a position on the object side in the direction of the first optical axis 10 where it does not overlap with the lens mount 102. Due to this configuration, even a lens with a relatively large diameter can be retracted completely from the first optical axis 10 without being restricted by a part that is difficult to avoid, such as the lens mount 102.

In a case where the imaging optical system moves from the second focal length range to the first focal length range, the first lens unit 110 first starts moving in the first direction 115 that is approximately parallel to the first optical axis 10 (FIG. 6). Just after the transition starts, the second lens unit 210 and the third lens unit 310 do not move in position.

In a case where the first lens unit 110 moves further toward the image plane along the first direction 115 beyond an intended focusing range, the second lens unit 210 then starts to retract in the second direction 215, and the third lens unit 310 starts to retract in the third direction 315 (FIG. 7).

In a case where the second lens unit 210 retracts further in the second direction 215 and the third lens unit 310 retracts further in the third direction 315 to reach a retracted position outside the optical path, the first lens unit 110 moves into the space created by the retraction. At this time, the maximum rotatable angles of the second lens unit 210 and the third lens unit 310 are 90 degrees or less. In a case where the imaging optical system has the second focal length range, the third lens unit 310 is disposed closer to the image plane than the second lens unit 210, but in a case where the imaging optical system has the first focal length range, the third lens unit 310 is disposed closer to the object than the second lens unit 210.

In this embodiment, the third lens unit 310 is heavier than the second lens unit 210 and has a longer retraction distance. In this structure, by disposing the second rotation shaft 325 in a phase opposite to that of the third direction 315 when viewed from the direction of the first optical axis 10, retraction in the third direction 315, which has a longer retraction distance than the second direction 215, becomes possible. Here, in a case where attention is paid to the retraction directions of the second lens unit 210 and the third lens unit 310, the second direction 215 and the third direction 315 are opposite directions with respect to the first optical axis 10. Placing them in opposing directions can cancel out and reduce vibrations and fluctuations at the center of gravity that occur in a case where the second lens unit 210 moves in the second direction 215 and the third lens unit 310 moves in the third direction 315.

As described above, FIGS. 5 to 8 illustrate the XZ plane viewed from above in the Y-axis direction. As illustrated in FIG. 2, the electrical connection member 101 is disposed on the lower side on the Y-axis, so the second lens unit 210 and the third lens unit 310 are retracted to different phases from the electrical connection member 101. Thereby, the space around the lens mount 102 can be used efficiently, and the size of the interchangeable lens 100 can be prevented from increasing.

In FIG. 5, the direction in which the centers of the first rotation shaft 225 and the second rotation shaft 325 extend is approximately parallel to the Y-axis. The direction in which the centers of the first rotation shaft 225 and the second rotation shaft 325 extend is substantially the same as the short side direction of the image sensor in the camera body 1, that is, the direction in which the light-shielding blades of the shutter unit 14 travel. During imaging, the front blades that travel from the light-shielding positions to the exposure positions collide with a stopper (not illustrated) and stop. In particular, since vibrations caused by the collision of the front blades occur during exposure, in a case where the vibrations caused by the collision are transmitted to the interchangeable lens 100, the image quality of the captured image may deteriorate. Accordingly, in this embodiment, the retraction directions of the second lens unit 210 and the third lens unit 310 are approximately orthogonal to the traveling direction of the front blades.

The Y-axis direction, which is the direction in which the centers of the first rotation shaft 225 and the second rotation shaft 325 extend, is generally parallel to the direction in which the user places the camera body 1 to which the interchangeable lens 100 is attached. That is, in a case where the user puts down the camera body 1, the interchangeable lens 100 receives an impact in the Y-axis direction, which is different from the direction in which the second lens unit 210 and the third lens unit 310 are retracted. Due to this structure, this embodiment can achieve a configuration that is sufficiently rigid and less susceptible to image quality degradation even against impacts generated by user handling.

Even after the second lens unit 210 and the third lens unit 310 have completed retraction, the first lens unit 110 can move in the first direction 115. Furthermore, in a case where the first lens unit 110 moves in the first direction 115 and completes its movement to an arbitrary position, the transition from the second focal length range to the first focal length range is completed (FIG. 8). In FIG. 8, the first lens unit 110 is located closest to the image plane compared to the states in FIGS. 5 to 7. That is, transitioning from the second focal length range to the first focal length range can reduce the overall length of the interchangeable lens 100.

As described above, imaging can be performed even in a case where the second lens unit 210 and the third lens unit 310 are retracted and the first lens unit 110 in FIG. 8 has moved to the image plane side to create the shortest overall lens length. In a case where the imaging optical system has the first focal length range, the first lens unit 110 is moved along the first optical axis 10 for focusing, as in the case of the second focal length range. In a case where the first lens unit 110 moves, the second lens unit 210 and the third lens unit 310 remain outside the optical path and do not move in position.

The case where the second focal length range is transitioned to the first focal length range has hitherto been described. Conversely, in a case where the first focal length range is transitioned to the second focal length range, the reverse procedure is followed to that illustrated in FIGS. 5 to 8. For example, in a case where the first lens unit 110 is moved from the image plane side to the object side by the user's operation, the second lens unit 210 and the third lens unit 310 rotate and move from the retracted position outside the optical path in FIG. 7 or 8 to a position in the optical path disposed on the first optical axis 10 in FIG. 6.

In a case where the second focal length range is transitioned to the first focal length range again, the second lens unit 210 and the third lens unit 310 are moved to the retracted position outside the optical path by the user's operation. Thus, in this embodiment, the interchangeable lens 100 is switchable between the first focal length range and the second focal length range without using a dedicated actuator.

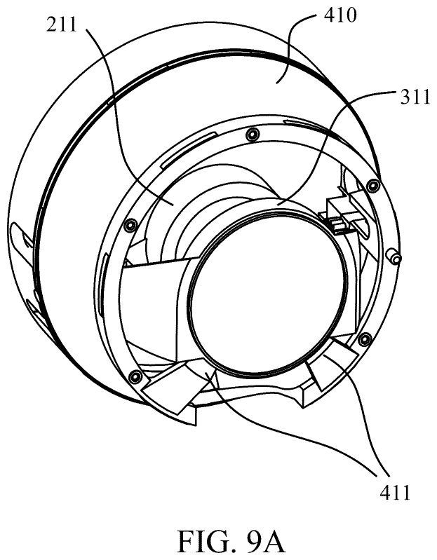

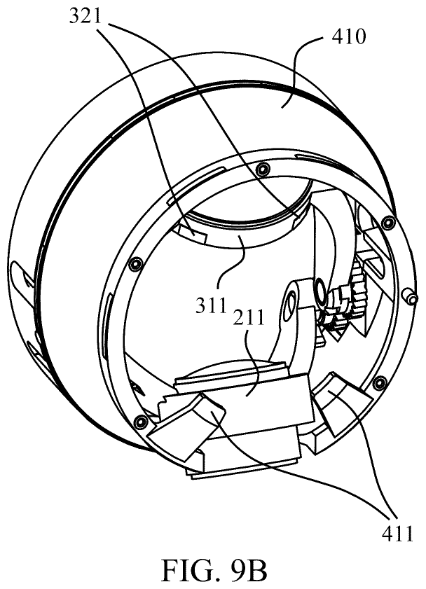

FIGS. 9A and 9B are perspective views of the second lens unit 210, the third lens unit 310, and the base member 410 when viewed from the object side. FIG. 9A illustrates the imaging optical system having the second focal length range, and FIG. 9B illustrates the imaging optical system having the first focal length range.

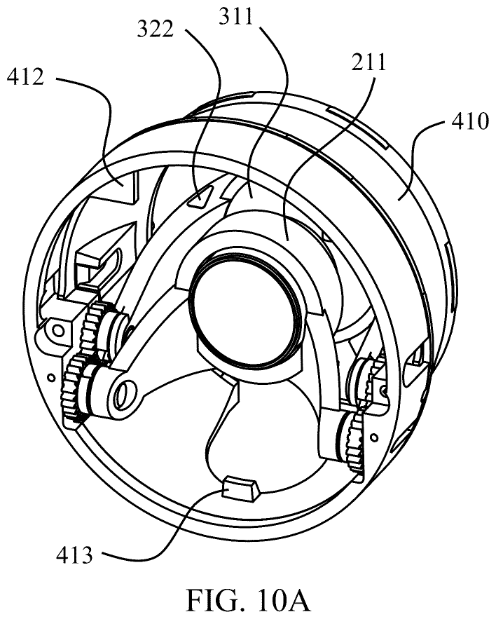

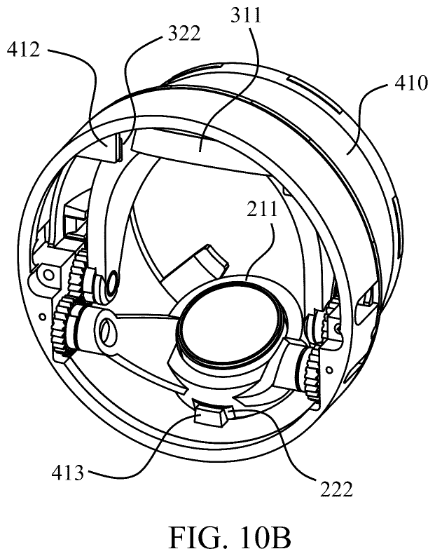

FIGS. 10A and 10B are perspective views of the second lens unit 210, the third lens unit 310, and the base member 410 when viewed from the image plane side. FIG. 10A illustrates the imaging optical system having the second focal length range, and FIG. 10B illustrates the imaging optical system having the first focal length range.

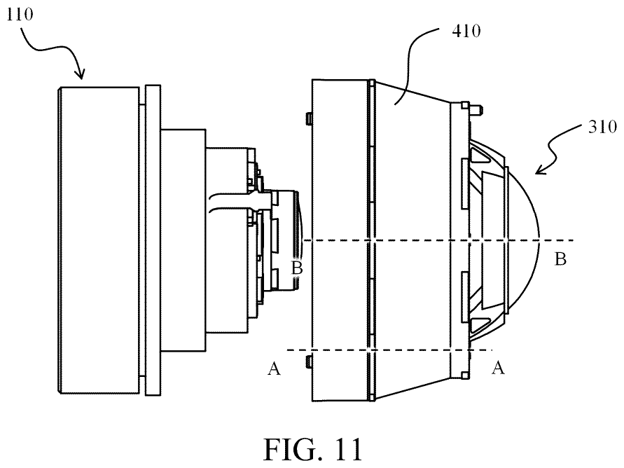

FIG. 11 is an external view of the second lens unit 210 and the third lens unit 310 held by the first lens unit 110 and the base member 410 when viewed from the Z direction.

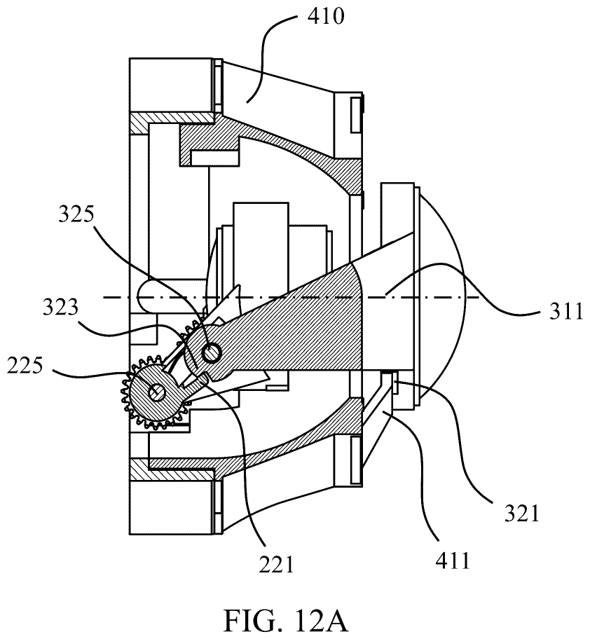

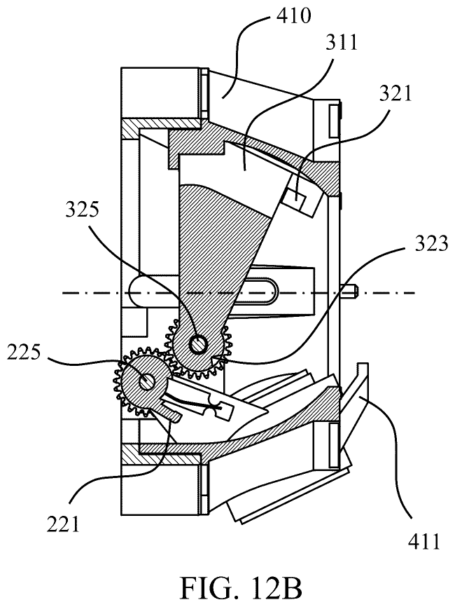

FIGS. 12A and 12B are sectional views taken along a line A-A in FIG. 11. FIG. 12A illustrates the imaging optical system having the second focal length range, and FIG. 12B illustrates the imaging optical system having the first focal length range.

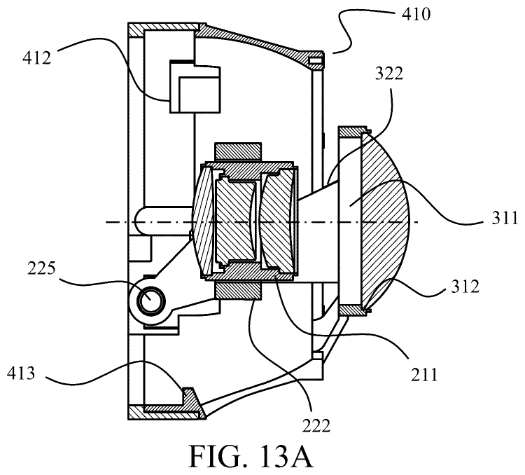

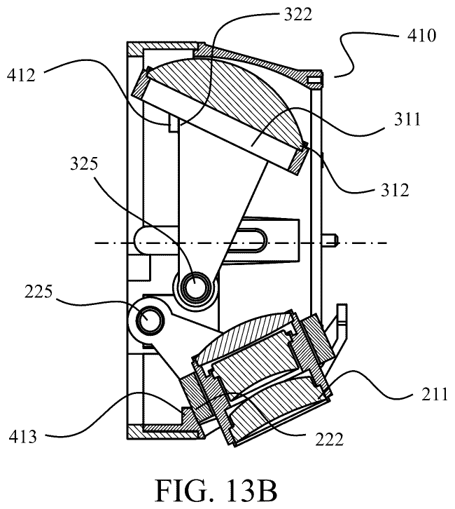

FIGS. 13A and 13B are sectional views taken along a line B-B in FIG. 11. FIG. 13A illustrates the imaging optical system having the second focal length range, and FIG. 13B illustrates the imaging optical system having the first focal length range.

As illustrated in FIGS. 9A to 12B, the base member 410 is a cylindrical fixed member fixed to the inner circumference of the fixed barrel 106. The base member 410 includes a second restricting portion 411. The third holding frame 311 includes a lens fitting portion (engagement portion) 312 that fits with (is engaged with) the second stopper portion 321 and the third lens unit 310. The second stopper portion 321 is disposed on the outer diameter side of the lens fitting portion 312, and is divided into at least two portions in a plane orthogonal to the first optical axis 10 in a direction parallel to the second rotation shaft 325. The third holding frame 311 is also provided with a first restricting portion 323. The second holding frame 211 includes a first stopper portion 221.

In a case where the imaging optical system has the second focal length range, the position of the second holding frame 211 is restricted by the contact of the first stopper portion 221 and the first restricting portion 323. That is, the position of the second holding frame 211 is restricted by the third holding frame 311. Thereby, the optical axis positions of the second lens unit 210 and the third lens unit 310 can easily coincide with each other, and optical performance is less likely to deteriorate even when an optical system, which is originally single, such as a conversion lens, is divided and retracted.

The position of the third holding frame 311 is restricted by the contact of the second stopper portion 321 and the second restricting portion 411. That is, the position of the third holding frame 311 is restricted by the base member 410 that directly holds the third holding frame 311. Thereby, the optical axes of the third lens unit 310 and the second lens unit 210 can easily coincide with the first optical axis 10, and optical performance is less likely to deteriorate.

Next follows a description of the arrangement of the first stopper portion 221 and the first restricting portion 323. As illustrated in FIG. 12A, the first stopper portion 221 and the first restricting portion 323 are arranged between the second rotation shaft 325 and the first rotation shaft 225. In FIG. 12A, in a case where the imaging optical system has the second focal length range, the third holding frame 311 is biased counterclockwise around the second rotation shaft 325 by a biasing member (not illustrated). On the other hand, the second holding frame 211 is biased clockwise around the first rotation shaft 225 by a biasing member (not illustrated). As described above, by placing the first stopper portion 221 and the first restricting portion 323 between these two rotation shafts, the force applied to the second holding frame 211 does not interfere with the force applied to the third holding frame 311. Thereby, the third holding frame 311 can be more reliably restricted at the inserted position.

As illustrated in FIGS. 10A to 13B, the base member 410 further includes a third restricting portion 413 and a fourth restricting portion 412. In addition, the third holding frame 311 includes a fourth stopper portion 322, and the second holding frame 211 includes a third stopper portion 222.

In a case where the imaging optical system has the first focal length range, the position of the third holding frame 311 is restricted by the contact of the fourth stopper portion 322 and the fourth restricting portion 412. The position of the second holding frame 211 is restricted by the contact of the third stopper portion 222 and the third restricting portion 413.

In this embodiment, the third restricting portion 413 and the fourth restricting portion 412 are formed integrally with the base member 410, but they may be formed as separate parts and fixed to the base member 410. In addition, the fourth stopper portion 322 is formed integrally with the third holding frame 311, but they may be formed as separate parts and fixed to the third holding frame 311. Furthermore, the third stopper portion 222 is formed integrally with the second holding frame 211, but they may be formed as separate parts and fixed to the second holding frame 211.

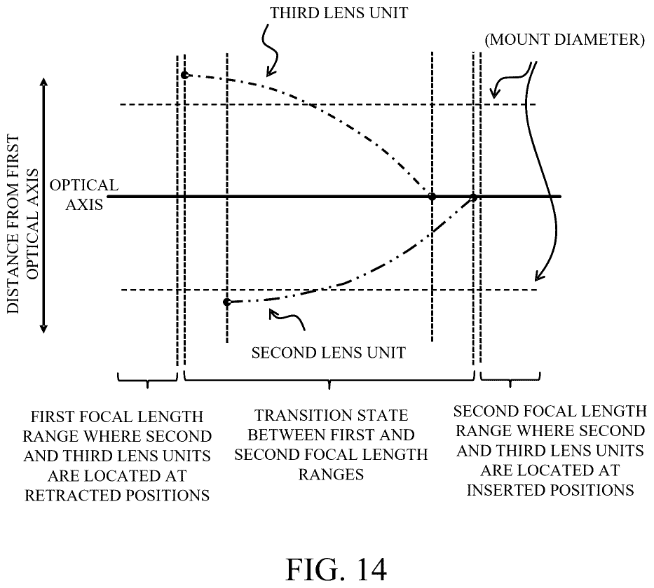

FIG. 14 is a graph illustrating a distance in a radial direction from the center of gravity of each of the second lens unit 210 and the third lens unit 310 to the first optical axis 10 in a case where the imaging optical system transitions between the first focal length range and the second focal length range. In FIG. 14, a horizontal axis represents the number of steps, and a vertical axis represents the distance to the first optical axis 10. Here, the number of steps indicates the state of transition from the second focal length range to the first focal length range, divided into steps. The upper side of the vertical axis in FIG. 14 is the grip portion 2 side, and the lower side is the side opposite to the grip portion 2.

In a case where the second lens unit 210 is considered and the second focal length range is transitioned to the first focal length range, the second lens unit 210 retreats in the second direction 215 and separates from the first optical axis 10. In a case where the third lens unit 310 is considered and the second focal length range is transitioned to the first focal length range, the third lens unit 310 retreats in a third direction 315 opposite the second direction 215. Therefore, the third lens unit 310 separates from the first optical axis 10, and increases a distance between the third lens unit 310 and the second lens unit 210. In this embodiment, the center of gravity of the third lens unit 310 moves in the third direction 315 toward the grip portion 2 of the camera body 1, and at the same time, the center of gravity of the second lens unit 210 moves in the second direction 215 opposite to the first optical axis 10. Thus, the changes in the centers of gravity cancel each other out, vibration is reduced, and a configuration that does not cause discomfort to the user can be achieved even during hand-held imaging.

In a case where the second focal length range is transitioned to the first focal length range (from right to left in FIG. 14), the first restricting portion 323 and the first stopper portion 221 separate from each other, and then the second restricting portion 411 and the second stopper portion 321 separate from each other. Then, the third restricting portion 413 and the third stopper portion 222 come into contact with each other, and then the fourth restricting portion 412 and the fourth stopper portion 322 come into contact with each other. That is, the second lens unit 210 starts and completes its movement from the inserted position to the retracted position before the third lens unit 310. By first retracting the second lens unit 210, which is closer to the first lens unit 110, the first lens unit 110 can efficiently enter the retracted space.

On the other hand, in a case where the transition from the first focal length range to the second focal length range (from left to right in FIG. 14) starts, the fourth restricting portion 412 and the fourth stopper portion 322 separate from each other, and then the third restricting portion 413 and the third stopper portion 222 separate from each other. That is, the third lens unit 310 starts moving from the retracted position to the inserted position before the second lens unit 210. By first inserting the third lens unit 310, which is farther from the first lens unit 110, into the space just after the first lens unit 110 starts moving toward the object, the transition of the focal length range can be efficient.

In a case where the transition from the first focal length range to the second focal length range is completed, the second restricting portion 411 and the second stopper portion 321 come into contact with each other, and then the first restricting portion 323 and the first stopper portion 221 come into contact with each other. That is, the third holding frame 311 completes its movement to the inserted position before the second holding frame 211 and is restricted by the base member 410. Since the position of the second holding frame 211 is restricted by the third holding frame 311, the third holding frame 311 is restricted at the inserted position first, and therefore the second holding frame 211 does not rotate beyond the intended inserted position.

FIG. 14 also illustrates, for reference, a distance from the fitting diameter (mount diameter) of the camera mount 7 and the lens mount 102 to the first optical axis 10. The first lens unit 110 is always disposed on the first optical axis 10 when viewed on a plane substantially parallel to the image plane, that is, from the direction of the first optical axis 10. On the other hand, the second lens unit 210 and the third lens unit 310 are disposed on the first optical axis 10 in the second focal length range, but are retracted from the first optical axis 10 in the first focal length range. Then, the second lens unit 210 and the third lens unit 310 are retracted to positions where parts of them is on the outer diameter side in the radial direction beyond the engagement diameter between the camera mount 7 and the lens mount 102 when viewed on a plane approximately parallel to the image plane, i.e., from the direction of the first optical axis 10.

Here, in a case where each of the second focal length range and the first focal length range is considered, the imageable range is from a close distance end to an infinity end, and the second lens unit 210 and the third lens unit 310 may be restricted from moving. Since various manufacturing errors and assembly variations exist in the interchangeable lens 100 and the camera body 1, the moving start and completion timings of the first lens unit 110, the second lens unit 210, and the third lens unit 310 may differ. Accordingly, in a case where the second focal length range is transitioned to the first focal length range, the second stopper portion 321 and the second restricting portion 411, and the first stopper portion 221 and the first restricting portion 323 are configured to start separating from each other after the first lens unit 110 starts moving toward the image plane side. The fourth stopper portion 322 and the fourth restricting portion 412, and the third stopper portion 222 and the third restricting portion 413 are configured to come into contact with each other before the first lens unit 110 completes its movement. Thus, this embodiment employs a configuration in which the moving timing of the first lens unit 110 and the moving timings of the second lens unit 210 and the third lens unit 310 are different, and which is less susceptible to the influence of manufacturing errors and assembly variations.

As described above, in this embodiment, the first lens unit 110 moves toward the image plane side by moving in the first direction 115 that is approximately parallel to the first optical axis 10. The second lens unit 210 moves in the second direction 215, and thereby moves toward the object side in the direction of the first optical axis 10 and separates from the first optical axis 10 in the radial direction. By moving in the third direction 315, the third lens unit 310 moves toward the object side in the direction of the first optical axis 10 and moves away from the second lens unit 210 in the radial direction. Due to this configuration, the transition from the second focal length range to the first focal length range is completed.

In this embodiment, the built-in conversion lens is configured by combining the second lens unit 210 and the third lens unit 310, but the present disclosure is not limited to this embodiment. For example, in another embodiment, the first focal length range and the second focal length range may be switched by at least the second lens unit 210 alone. In this case, the third lens unit 310 may be a neutral density filter, a protective filter, or a polarizing filter.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This embodiment can provide an optical apparatus that enables a retractable lens unit to be inserted and retracted without deteriorating optical performance.

This application claims the benefit of Japanese Patent Application No. 2024-143385, which was filed on Aug. 23, 2024, and which is hereby incorporated by reference herein in its entirety.

What is claimed is:

1. An optical apparatus comprising:
an optical system that includes a first lens unit, a second lens unit, and a third lens unit;
a first holding member that includes a first stopper portion and holds the second lens unit;
a second holding member that includes a first restricting portion and a second stopper portion and holds the third lens unit; and
a fixed member that includes a second restricting portion and holds the first holding member and the second holding member,
wherein the second lens unit and the third lens unit are movable between a first state in which the second lens unit and the third lens unit are located outside an optical path of the optical system and a second state in which the second lens unit and the third lens unit are located in the optical path of the optical system, and
wherein in a case where the second lens unit and the third lens unit are in the second state, the first restricting portion contacts the first stopper portion, and the second restricting portion contacts the second stopper portion.

2. The optical apparatus according to claim 1, wherein in a case where the second lens unit and third lens unit move from the first state to the second state, the second restricting portion and the second stopper portion come into contact with each other, and then the first restricting portion and the first stopper portion come into contact with each other.

3. The optical apparatus according to claim 1, wherein the second holding member moves to the first state and the second state by rotating about a rotation axis orthogonal to an optical axis determined by the first lens unit.

4. The optical apparatus according to claim 3, wherein the second holding member has a fitting portion that fits with the third lens unit, and
wherein the second stopper portion is located on an outer diameter side of the fitting portion and is divided into at least two in a plane orthogonal to the optical axis in a direction parallel to the rotation axis.

5. The optical apparatus according to claim 1, wherein the first holding member includes a third stopper portion,
wherein the second holding member includes a fourth stopper portion,
wherein the fixed member includes a third restricting portion and a fourth restricting portion, and
wherein in a case where the second lens unit and the third lens unit are in the first state, the third restricting portion and the third stopper portion contact each other, and the fourth restricting portion and the fourth stopper portion contact each other.

6. The optical apparatus according to claim 5, wherein in a case where the second lens unit and the third lens unit move from the second state to the first state, the third restricting portion and the third stopper portion come into contact with each other, and then the fourth restricting portion and the fourth stopper portion come into contact with each other.

7. The optical apparatus according to claim 1, wherein the first holding member moves to the first state and the second state by rotating about a rotation axis orthogonal to an optical axis determined by the first lens unit.

8. The optical apparatus according to claim 1, wherein the first holding member moves to the first state and the second state by rotating about a first rotation axis orthogonal to an optical axis determined by the first lens unit,
wherein the second holding member moves to the first state and the second state by rotating about a second rotation axis orthogonal to the optical axis determined by the first lens unit, and
wherein in a case where the second lens unit and the third lens unit are in the second state, the first restricting portion and the first stopper portion are located between the first rotation axis and the second rotation axis.

9. The optical apparatus according to claim 1, wherein in a case where the second lens unit and the third lens unit are in the second state, the second lens unit is located closer to an image plane than the first lens unit, and the third lens unit is located closer to the image plane than each of the first lens unit and the second lens unit.

10. The optical apparatus according to claim 1, wherein the first lens unit includes a focus lens, and
wherein focusing of the optical system is performed when the focus lens moves along a direction parallel to an optical axis determined by the first lens unit.

11. The optical apparatus according to claim 10, further comprising an operation member rotatable around the optical axis,
wherein the focus lens moves according to a rotation of the operation member.

12. The optical apparatus according to claim 1, wherein in a case where the second lens unit and third lens unit are in the first state, a focal length range of the optical system is a first focal length range, and
wherein in a case where the second lens unit and the third lens unit are in the second state, the focal length range is a second focal length range different from the first focal length range.

13. An image pickup apparatus comprising:
an optical apparatus; and
an image sensor;
wherein the optical apparatus includes:
an optical system that includes a first lens unit, a second lens unit, and a third lens unit;
a first holding member that includes a first stopper portion and holds the second lens unit;
a second holding member that includes a first restricting portion and a second stopper portion and holds the third lens unit; and
a fixed member that includes a second restricting portion and holds the first holding member and the second holding member,
wherein the second lens unit and the third lens unit are movable between a first state in which the second lens unit and the third lens unit are located outside an optical path of the optical system and a second state in which the second lens unit and the third lens unit are located in the optical path of the optical system, and
wherein in a case where the second lens unit and the third lens unit are in the second state, the first restricting portion contacts the first stopper portion, and the second restricting portion contacts the second stopper portion.
